(19) United States
(12) Patent Application Publication
(10) Pub. No.: US 2009/0276282 A1
(43) Pub. Date: Nov. 5, 2009

(54) APPOINTMENT REMINDER AND SYSTEMS AND METHODS FOR MAKING AND USING

(76) Inventor: S. Todd Smith, Bellevue, WA (US)

Correspondence Address: DARBY & DARBY P.C., P.O. BOX 770, Church Street Station, New York, NY, 10008-0770, US

(21) Appl. No.: 12/114,366

(22) Filed: May 2, 2008

(51) Int. Cl. G06F 9/46

(52) U.S. Cl. 705/9

(57) ABSTRACT

A service package includes a brochure that includes general information related to a service provided for a client by a service provider. An appointment notifier may be inserted into the brochure. A client-specific insert may also be inserted into the brochure. The appointment notifier may include a reminder packet with information related to the date and time of day of a future service appointment between the client and the service provider and a gift card for use by the client. The client-specific insert may include client-specific information relating to the service provided for the client by the service provider.

### TECHNICAL FIELD

The present invention is directed to the area of appointment reminders. The present invention is also directed to systems and methods for a service provider to provide an appointment reminder to a client, the appointment reminder including future-appointment information related to a future service appointment with the service provider and a client-retention incentive for encouraging the client to remain a client.

### BACKGROUND

Service providers, such as dentists, doctors, accountants, hair/make-up stylists, and the like, may make a living by providing services to clients. Attracting new clients, as well as retaining current clients, is often an important concern. In most markets, competition among service providers is fierce. As a result, some service providers may opt to provide certain client-attraction and client-retention incentives, such as reduced prices for services. However, providing such incentives may cut into service-provider profits and be burdensome or expensive to create and maintain.

In some industries, maintaining a steady flow of clients is also a concern to some service providers. A service provider may lose money when service time slots remain unfilled. In addition to losing out on potential income from clients during open service time slots, a service provider may also have a number of different overhead costs that need to be paid regardless of whether service time slots are open or filled, such as employment costs for assistants, equipment costs, destruction of perishable items or limited-life equipment, and the like. In some cases, service time slots may be open due to clients being lured away to other service providers with appealing client-attraction incentives. In other cases, service time slots may be open due to clients canceling or forgetting to show up for scheduled appointments. In order to lessen the number of clients forgetting to show up for scheduled appointments, some service providers may send out one or more reminders to clients reminding the clients of future appointments.

In order to keep a business profitable, it may be useful for a service provider to have at least some business acumen. As an example, it may be financially advantageous for a service provider to be able to make adjustments to the type of services offered in order to favor providing services with higher profit margins. For example, a given service may have a price that is set by a market or by a code of practice in an industry. However, a service provider may not be able to adequately perform the service for the set price without incurring a financial loss. Accordingly, it may not be in the best financial interest of a service provider to perform every service he or she is capable of performing. Unfortunately, it may be the case that consumers are unable to obtain certain desired services because providing the services are not profitable enough for the service provider to perform.

As another example, it may be financially advantageous for a service provider to be able to negotiate beneficial deals and create business relationships with third-party businesses that supply products to the service provider for use in the service provider's practice. Sometimes a service provider may be able to negotiate a more favorable price on products when the service provider agrees to exclusively use the third-party businesses' products, or when the service provider agrees to advertise the third-party businesses' product. It may be the case that increasing the amount of advertising that a service provider performs for a third-party businesses' product reduces the price for that product that the service providers pays which, in turn, may translate to either or both an increase in profit for the service provider, or a reduced price to clients of the service provider.

### BRIEF DESCRIPTION OF THE DRAWINGS

Non-limiting and non-exhaustive embodiments of the present invention are described with reference to the following drawings. In the drawings, like reference numerals refer to like parts throughout the various figures unless otherwise specified.

For a better understanding of the present invention, reference will be made to the following Detailed Description, which is to be read in association with the accompanying drawings, wherein:

FIG. 1A is a schematic front view of one embodiment of an appointment notifier with a foldable reminder packet in an open position and a gift card configured and arranged for insertion into the reminder packet, according to the invention;

FIG. 1B is a schematic front view of one embodiment of the appointment notifier shown in FIG. 1A with a gift card inserted into a partially-folded reminder packet, according to the invention;

FIG. 1C is a schematic front view of one embodiment of the appointment notifier shown in FIG. 1A with a folded reminder packet, according to the invention;

FIG. 2A is a schematic front view of one embodiment of a service package with a brochure in an open position and a client-specific insert, a post-service item, an optical disc, and an appointment notifier each configured and arranged for insertion into the brochure, according to the invention;

FIG. 2B is a schematic front view of one embodiment of the service package shown in FIG. 2A with a partially folded brochure that includes a client-specific insert, a post-service item, an optical disc, and an appointment notifier each inserted into the brochure, according to the invention;

FIG. 2C is a schematic front view of one embodiment of the service package shown in FIG. 2A with a folded brochure, according to the invention; and

FIG. 3 illustrates a flow diagram showing one embodiment of exemplary steps used by a service provider for providing a client with a reminder of a future appointment with the service provider, according to the invention.

### DETAILED DESCRIPTION

The present invention is directed to the area of appointment reminders. The present invention is also directed to systems and methods for a service provider to provide an appointment reminder to a client, the appointment reminder including future-appointment information related to a future service appointment with the service provider and a client-retention incentive for encouraging the client to remain a client.

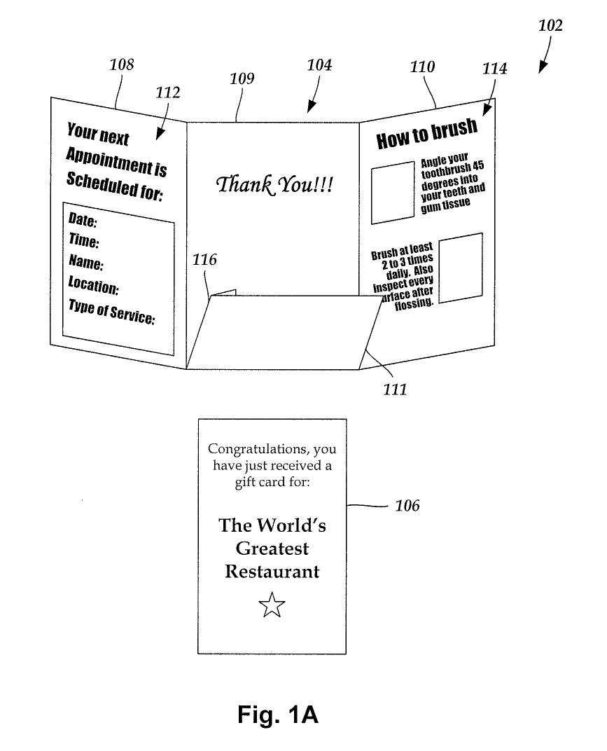

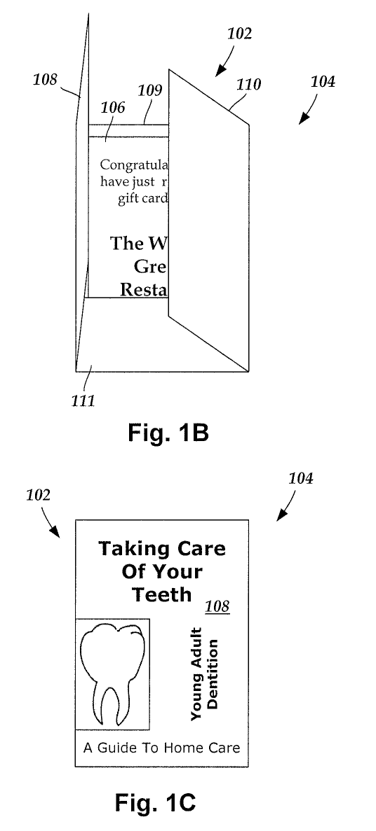

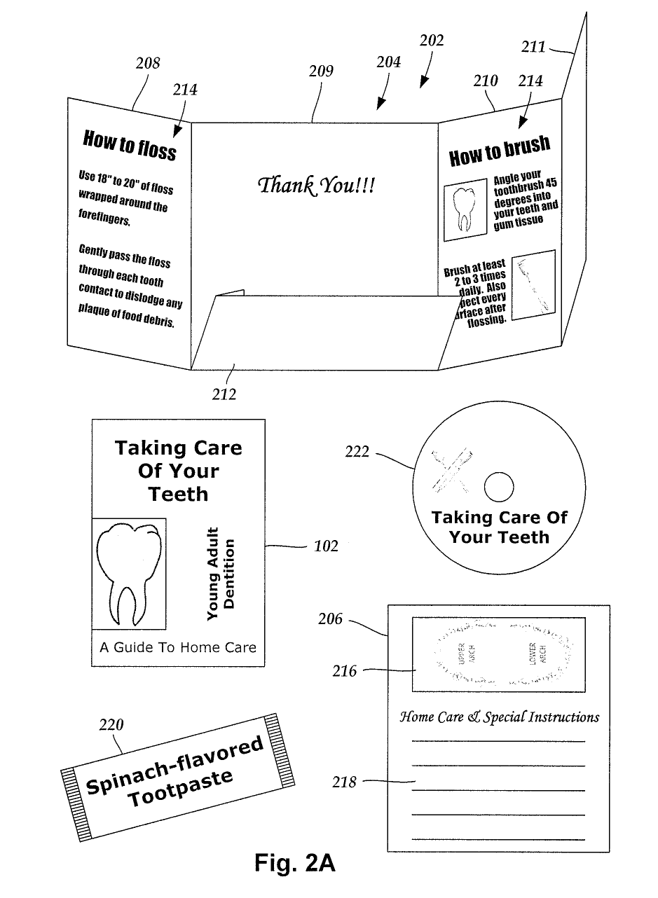

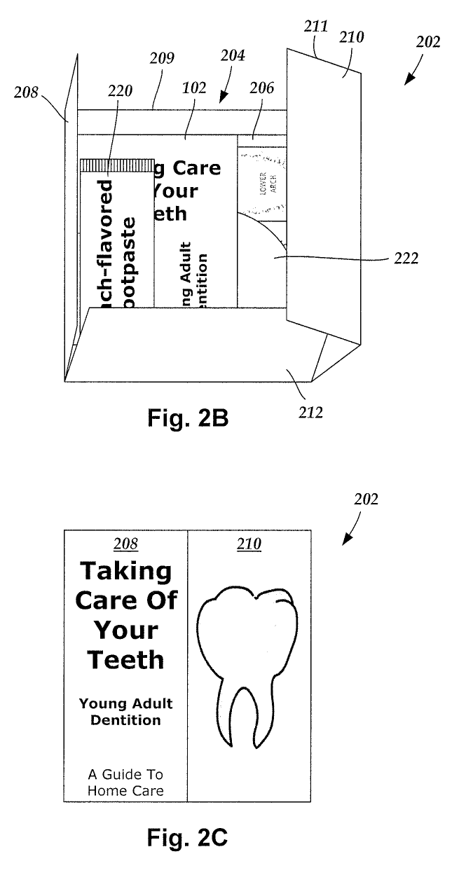

In at least some embodiments, a service provider may include one or more assistants, employees, or affiliates of the service provider. In at least some embodiments, a client may include at least one designee of the client. In FIGS. 1A-2C a dentist is used as an exemplary service provider that provides one or more dentistry services to a client. A dentist and dentistry are meant to serve merely as examples of service providers and services and are not meant to be limiting in scope.

In at least some embodiments, an appointment reminder includes an appointment notifier that may be provided to a client by a service provider. FIG. 1A is a schematic front view of one embodiment of an appointment notifier 102. The appointment notifier 102 includes a reminder packet 104 and a gift card 106. The reminder packet 104 can be formed from at least one sheet of material suitable for displaying printed material, such as paper, cardboard, plastic, and the like. The reminder packet 104 can be formed in any number of shapes and sizes suitable for displaying the printed material and removably retaining the gift card 106.

In at least some embodiments, the reminder packet is foldable. In FIG. 1A, the reminder packet 104 is shown in an open position and includes vertical folds that divide the reminder packet 104 into three horizontal panels 108-110. The reminder packet 104 also includes a horizontal fold along the horizontal panel 109 that forms another panel 111. Different numbers of panels may be disposed on a reminder packet 104. For example, there may be one, two, three, four, five, six, seven, eight, or more panels disposed on a reminder packet 104. In at least some embodiments, the reminder packet 104 includes a different orientation of panels from the panels shown in FIG. 1A. For example, in at least some embodiments, the reminder packet 104 includes two horizontal folds that divide the reminder packet 104 into three vertical panels and two vertical folds disposed along at least a portion of one or more of the vertical panels that form two additional panels.

In at least some embodiments, the reminder packet 104 includes future-appointment information 112 to facilitate the client attending a future service appointment by providing the client with pertinent details of the future service appointment. For example, future-appointment information 112 may include one or more pertinent details, such as the date and the time of the future service appointment, as well as the name of the client, the location of the performance of the service, and the type of service to be performed. The future-appointment information 112 may be positioned anywhere on the reminder packet 104. In FIG. 1A, the future-appointment information 112 is shown on the panel 108.

In at least some embodiments, the reminder packet 104 includes general information 114 related to the service provided for the client by the service provider. For example, a dentist may clean a patient's teeth and then provide the patient with information about general techniques for home teeth cleaning. In FIG. 1A, the general information concerns proper teeth brushing techniques. The general information 114 may be positioned anywhere on the reminder packet 104. In FIG. 1A, the general information 114 is shown on the panel 110. In at least some embodiments, a service provider may provide more than one service and, accordingly, the reminder packet 104 may include different types of general information 114 depending on which services are provided for a client by the service provider. For example, a dentist may have general information relating to a number of different services including, for example, primary dentition, mixed dentition, young adult dentition, mature dentition, pre-bleaching, general cleaning, pre-restorative treatment, and the like or combinations therein.

In at least some professions, one or more administrative bodies may directly or indirectly govern the professional practice of a service provider. This may especially be the case when a service provider has one or more specific licenses that enable the service provider to provide one or more restricted-practice types of services. For example, the American Dental Association may govern a professional practice of a dentist licensed to practice dentistry. Sometimes, the one or more governing bodies may provide guidance with respect to allowable billing practices that a professional service provider must follow in order to retain his or her professional license. Sometimes a service provider may charge a certain amount of money to a client to provide certain types of general information to a client. For example, the American Dental Association may allow a licensed dentist to charge a client a certain amount of money to provide the client with general information relating to home health care, such as tooth brushing techniques, flossing, and the use of special oral hygiene aids. However, in some cases, the amount of money that a service provider can charge a client to provide the general information for the client is less than the amount of money that it costs the service provider to provide the information. Thus, in at least some embodiments, the general information 114 included in the appointment notifier 102 satisfies the requirements of an applicable governing body for providing billable general information to a client. In at least some embodiments, the cost of providing the reminder packet 104 is at least partially offset by the money charged to the client for administering the general information 114, when the general information 114 satisfies the requirements of an applicable governing body for providing billable general information to the client.

In at least some embodiments, the reminder packet 104 includes at least one business card or referral card. In at least some embodiments, the future-appointment information 112 is displayed on the at least one business card or referral card. In at least some embodiments, the general information 114 is displayed on the at least one business card or referral card. In at least some embodiments, the future-appointment information 112 and the general information is displayed on the at least one business card or referral card.

In at least some embodiments, the gift card 106 is provided as a client-retention incentive to encourage the client to return for a future service appointment with the service provider. The gift card 106 may be redeemed toward any number of products or services offered from one or more third-party businesses or affiliates of one or more of the third-party businesses. For example, the gift card 106, may be for one or more restaurants, one or more gas stations, one or more movie theaters, one or more coffee shops, one or more airlines, and the like or combinations thereof. In FIG. 1A, the gift card 106 is for a restaurant. The gift card 106 may be for any number of denominations. In at least some embodiments, the gift card 106 needs to be activated by the client. In at least some embodiments, the gift card 106 may be activated via a website. In at least some embodiments, the gift card 106 has a refillable balance.

A service provider may incur several benefits by providing the gift card 106 to a client. As discussed above, the gift card 106 may encourage the client to return for a future service appointment, thereby providing a client-retention service. Additionally, the gift card 106 may spread goodwill in the community. The service provider's business may increase by the client telling his or her friends, family, and co-workers about the service provided and the gift card 106 received after the service. Additionally, in at least some embodiments the price of the gift card 106 paid by the service provider is, at least partially, offset by the money charged to the client for administering the general information 114, when the general information 114 satisfies the requirements of an applicable governing body for providing billable general information to the client.

In at least some embodiments, the reminder packet 104 is configured and arranged to removably retain the gift card 106. The reminder packet 104 may removably retain the gift card 106 in many different ways such as, for example, the gift card 106 may be removably affixed to the reminder packet 104, the gift card 106 may be placed in a sleeve affixed to the reminder packet 104, the gift card 106 may be rubber-banded to the reminder packet 104, the gift card 106 may be bound to the reminder packet 104, and the like or combinations thereof. In FIG. 1A, the panel 111 of the reminder packet 104 can be folded against the panel 109 to form a pocket within which the gift card 106 may be placed. In at least some embodiments, the reminder packet 104 includes one or more additional folds, such as fold 116, to facilitate removably retaining the gift card 106. In at least some embodiments, the reminder packet 104 includes one or more additional panels to facilitate removably retaining the gift card 106. Additionally, one or more slits or tabs may also be used to removably retain the gift card 106.

FIG. 1B is a schematic front view of one embodiment of the appointment notifier 102 with the gift card 106 inserted into the reminder packet 104. The gift card 106 is inserted into a pocket formed by folding the panel 111 against the panel 109. The panels 108 and 110 are also partially folded against the panel 109. In at least some embodiments, additional general information 114 can be disposed on either or both the back side or the front side of one or more of the panels 108-111. In at least some embodiments, information about the service provider can be disposed on either or both the back side or the front side of one or more of the panels 108-111. In at least some embodiments, information about the third-party business offering the services or products for which the gift card 106 may be redeemed can be disposed on either or both the back side or the front side of one or more of the panels 108-111.

In at least some embodiments, information about a third-party entity other than the service provider or the third-party business offering the services or products for which the gift card 106 may be redeemed can be disposed on either or both the back side or the front side of one or more of the panels 108-111. For example, the reminder packet 104 may include an advertisement for the third-party entity. In at least some embodiments, at least a portion of the cost of providing the reminder packet 104 or the gift card 106 may be offset by displaying one or more advertisements on the reminder packet 104. In at least some embodiments, the third-party entity may be affiliated with the service provided by the service provider or one or more products used by the service provider to perform a service for a client. When the third-party entity is affiliated with the service provided by the service provider or one or more products used by the service provider to perform a service for a client, the third-party entity may incur a benefit of marketing directly to people that may either directly or indirectly need or desire one or more of the products (or even other services) provided by the third-party entity that are suitable for sale to the client.

FIG. 1C is a schematic front view of one embodiment of the appointment notifier 102 with the reminder packet 104 folded into a closed position. In FIG. 1C, the reminder packet 104 is folded so that the front side of the reminder packet 104 is the back side of the panel 108 shown in FIG. 1A. In at least some embodiments, the reminder packet 104 is folded so that the front side of the reminder packet 104 is the back side of the panel 110 shown in FIG. 1A. In at least some embodiments, the reminder packet 104 is folded so that the front side of the reminder packet 104 is the panel 111. In at least some embodiments, the reminder packet 104 is folded so that the front side of the reminder packet 104 is a combination of two or more of the panels 108, 110, and 111.

In at least some embodiments, an appointment reminder includes a service package that may be provided from a service provider to a client. In at least some embodiments, the service package includes the appointment notifier 102. FIG. 2A is a schematic front view of one embodiment of a service package 202. The service package 202 includes a brochure 204, the appointment notifier 102, and a client-specific insert 206. The brochure 204 can be formed from any material suitable for displaying printed material, such as paper, cardboard, plastic, and the like. The brochure 204 can be formed in any number of shapes and sizes suitable for removably retaining the appointment notifier 102 and the client-specific insert 206.

In at least some embodiments, the brochure 204 is foldable. In FIG. 2A, the brochure 204 is shown in an open position and includes vertical folds that divide the brochure 204 into four horizontal panels 208-211. The brochure 204 also includes a horizontal fold along the horizontal panel 209 that forms another panel 212. Different numbers of panels may be disposed on a brochure 204. For example, there may be one, two, three, four, five, six, seven, eight, or more panels disposed on a brochure 204. In at least some embodiments, the brochure 204 includes a different orientation of panels from the panels shown in FIGS. 2A. For example, in at least some embodiments, the brochure 204 includes two horizontal folds that divide the brochure 204 into three vertical panels and two vertical folds disposed along at least a portion of one or more of the vertical panels that form two additional panels.

In at least some embodiments, the brochure 204 includes general information 214 related to the service provided for the client by the service provider. For example, in FIG. 2A, the general information concerns proper flossing techniques and proper teeth brushing techniques. In at least some embodiments, the general information 214 included on the brochure 204 satisfies the requirements of an applicable governing body for providing billable general information to a client. In at least some embodiments, at least a portion of the cost of the components of the appointment notifier 102 and the brochure 204 are offset by the money charged to the client for administering the general information 214, when the general information 214 satisfies the requirements of an applicable governing body for providing billable general information to the client.

The general information 214 may be positioned anywhere on the brochure 204. In FIG. 2A, the general information 214 is shown on the panels 208 and 210. In at least some embodiments, a service provider may provide more than one service and, accordingly, the brochure 204 may include different types of general information 214 depending on which services are provided for a client by the service provider.

The client-specific insert 206 can be formed from any material suitable for displaying printed material, such as paper, cardboard, plastic, and the like. The client-specific insert 206 can be formed in any number of shapes and sizes suitable for being inserted into the brochure 204. In at least some embodiments, the client-specific insert 206 includes client-specific information related to a service provided for the client by the service provider, such as a statement about a specific client condition or instructions or suggestions for the client to follow prior to a future service appointment with the service provider. For example, in FIG. 2A the client-specific insert 206 includes a diagram 216 and a series of lines 218. In FIG. 2A, the diagram 216 includes a set of teeth that may be used to indicate trouble areas in a client's mouth that need special attention. For example, one or more specific teeth may be marked on the diagram 216 to indicate that during a client examination, a dentist discovered some of the client's teeth that correspond to the marked teeth on the diagram 216 have a specific condition and need special attention. Consequently, the dentist may communicate to the client that the client needs to regularly apply a medication to the teeth needing special attention for a set period of time. In FIG. 2A, the series of lines are configured and arranged to provide a place for a service provider to record client-specific information. For example, a service provider may write instructions for a client on how and when to apply medication to the teeth marked on the diagram 216.

In at least some embodiments, the service package 202 also includes at least one post-service item 220 related to the service provided for the client by the service provider. In at least some embodiments, the at least one post-service item 220 may serve as another client-retention incentive. In a preferred embodiment, the at least one post-service item 220 is configured and arranged for insertion into, or attachment to, the brochure 204. In at least some embodiments, the post-service item 220 is affiliated with a third-party business. For example, the third-party business may be a company that manufactures one or more dental-related items may provide one or more items, such as packets of toothpaste, dental floss, toothbrushes, mouthwash, and the like, for insertion into the service package 202. In FIG. 2A, the post-service item 220 is shown as a packet of toothpaste.

In at least some embodiments, the post-service item 220 may be provided by the third-party business as part of a marketing campaign. In at least some embodiments, the post-service item 220 may be a promotional item. In at least some embodiments, the third-party business may request feedback from clients after use. In at least some embodiments, the third-party business affiliated with the post-service item 220 is not the same third-party business through which the gift card 106 may be redeemed. The third-party business providing the post-service item 220 may incur a benefit by marketing a brand name and an item to a specific group of people that, following exposure to the post-service item 220, may become subsequent retail purchasers of the item. In at least some embodiments, the cost of providing the service package 202 is at least partially paid for by the third-party business providing the post-service item 220.

In at least some embodiments, the brochure 204 includes printed materials relating to the service provider. In at least some embodiments, the brochure 204 includes printed materials relating to the third-party business affiliated with the post-service item 220. In at least some embodiments, the brochure 204 includes printed materials relating to the third-party business through which the gift card 106 may be redeemed. In at least some embodiments, the brochure 204 includes printed materials relating to a third-party entity that is neither the third-party business through which the gift card 106 may be redeemed nor the third-party business affiliated with the post-service item 220. For example, the brochure 204 may include an advertisement for the third-party entity. In at least some embodiments, at least a portion of the cost of providing the brochure 204 or the appointment notifier 102 may be offset by displaying one or more advertisements on the reminder packet 104. In at least some embodiments, the third-party entity may be affiliated with the service provided by the service provider or one or more products used by the service provider to perform a service for a client. When the third-party entity is affiliated with the service provided by the service provider or one or more products used by the service provider to perform a service for a client, the third-party entity may incur a benefit of marketing directly to people that may either directly or indirectly need or desire one or more of the products (or even other services) provided by the third-party entity that are suitable for sale to the client.

In at least some embodiments, the service package 202 also includes one or more optical discs 222, such as CDs, DVDs, Blu-ray discs, HD-DVDs, and the like. In at least some embodiments, the one or more optical discs 222 include viewable content that includes general information 214 related to the service provided for the client by the service provider. In at least some embodiments, the general information 214 included in the viewable content on the one or more optical discs 222 satisfies the requirements of an applicable governing body for providing billable general information to a client. In at least some embodiments, the viewable content of one or more optical discs 222 includes information relating to at least one of the service provider, the third-party business affiliated with the post-service item 220, the third-party business through which the gift card 106 may be redeemed, or another third-party entity other than the above-listed entities.

In at least some embodiments, the appointment notifier 102, the client-specific insert 206, the at least one post-service item 220, the one or more optical discs 222, and the brochure 204 can be placed together into a container, such as a folder, a bag, a box, a file, a sheath, a tube, and the like. In at least some embodiments, the appointment notifier 102, the client-specific insert 206, the at least one post-service item 220, and the one or more optical discs 222 can be inserted into the brochure 204. Accordingly, in at least some embodiments the brochure 204 can be configured and arranged in many different possible shapes and sizes in order to accommodate the appointment notifier 102, the client-specific insert 206, the at least one post-service item 220, and the one or more optical discs 222.

FIG. 2B is a schematic front view of one embodiment of the service package 202 with the appointment notifier 102, the client-specific insert 206, the at least one post-service item 220, and the one or more optical discs 222 inserted into the brochure 204. In FIG. 2B, the appointment notifier 102, the client-specific insert 206, the at least one post-service item 220, and the one or more optical discs 222 are shown inserted into a pocket formed by folding the panel 212 against the panel 209. The panel 211 is shown partially folded against the panel 210 which, in turn, along with the panel 208, are each shown partially folded against the panel 209.

FIG. 2C is a schematic front view of one embodiment of the service package 202. As discussed above, the brochure 204 may be folded in many different ways to accommodate the appointment notifier 102, the client-specific insert 206, the at least one post-service item 220, and the one or more optical discs 222. In FIG. 2C, the brochure 204 is folded so that the front side of the brochure 204 is formed from the back sides of the panels 208 and 210 shown in FIG. 2A. In at least some embodiments, the brochure 204 is folded so that the front side of the brochure 204 is the panel 212. In alternate embodiments, the brochure 204 is folded so that the front side of the brochure 204 is the back side of only the panel 208, or only the panel 210, or a combination of all of the panels 208, 210, and 211, or any of the above combinations combined with the panel 212.

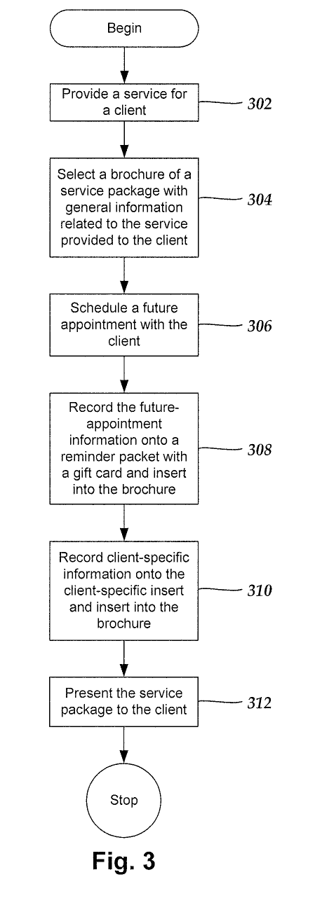

In at least some embodiments, a service provider may provide a service for a client and then present the client with an appointment reminder regarding a future service appointment. In some embodiments, the service provider may provide the client with the reminder packet 104. In other embodiments, the service provider may provide the client with the service package 202 which, in turn, may include the reminder packet 104. FIG. 3 illustrates a flow diagram showing one embodiment of exemplary steps used by a service provider to form a service package 202 and present the service package to a client. In a first step 302, a service provider provides a service for a client. In a second step 304, the service provider selects the brochure 204 of a service package 202 which includes general information 214 relating to the service provided for the client. In at least some embodiments, the service provider verifies that the included general information 214 meets any necessary standards, guidelines, or requirements needed to bill the client for the client with the general information 214. In a third step 306, the service provider schedules an appointment with the client to provide a future service for the client. In a fourth step 308, the service provider records future-appointment information onto the reminder packet 104 which, in turn, is placed in the appointment notifier 102 along with the gift card 106, and the appointment notifier 102 is then placed in the brochure 204. In a fifth step 310, the service provider records client-specific information onto the client-specific insert 206 and inserts the client-specific insert into the brochure 204. In a sixth step 312, the service provider presents the service package 204 to the client. In at least some embodiments, the service package includes at least one post-service item 220. In at least some embodiments, the service package 202 includes one or more optical discs 222.

In at least some embodiments, a website may be displayed on the service package 202 through which a client may access one or more personal pages related to the service performed by the service provider. In at least some embodiments, a client may access the one or more personal pages and receive account information with the service provider. In at least some embodiments, the client may buy products from one or more of the service provider, one of the third-party businesses, or another third-party entity through the website. In at least some embodiments, the client may verify completion of all, or a portion of a regimen or other suggested activity listed on the client-specific insert 206.

Accordingly, in at least some embodiments, while receiving a reminder of a future service appointment; a client may also receive the benefit of a gift card, a post-service item, and useful general information related to a service provided by a service provider. A service provider, while providing the client with the reminder of the future service appointment, may receive the benefit of creating a new stream of revenue by charging the client for dispensing information to the client that may not otherwise be profitable to dispense, providing the client with client-retention incentives to increase the likelihood of the client remaining a client, advertising through word of mouth by the client about the client-retention incentives, and spreading goodwill throughout the community by purchasing gift cards from third-party businesses. Additionally, the third-party business providing a post-service item may incur a benefit of selected marketing to a targeted audience of potential future customers, the third-party business supplying the gift cards incurs a benefit of increased sales stemming from the sale of the gift cards plus potential additional revenue for increased sales above the amount of the gift card, as well as potential future business by people redeeming their gift cards.

The above specification, examples and data provide a description of the manufacture and use of the composition of the invention. Since many embodiments of the invention can be made without departing from the spirit and scope of the invention, the invention also resides in the claims hereinafter appended.

What is claimed as new and desired to be protected by Letters Patent of the United States is:

1. A method for a service provider to remind a client of a future service appointment, the method comprising:
providing a service for the client;
selecting a brochure of a service package, the brochure displaying general information related to the service provided for the client by the service provider;
scheduling a future service appointment with the client;
recording information relating to the future service appointment;
inserting the future-appointment information into the brochure along with a gift card;
recording client-specific information relating to the service provided for the client by the service provider;
inserting the client-specific information into the brochure; and
presenting the service package to the client.

2. The method of claim 1, wherein presenting the service package to the client further comprises presenting the service package so that the service package comprises at least one post-service item related to the service provided for the client.

3. The method of claim 2, wherein the cost associated with providing to the client the at least one post-service item related to the service provided for the client is at least partially paid for by a third-party business.

4. The method of claim 1, wherein presenting the service package to the client further comprises presenting the service package so that the service package comprises an optical disc, the optical disc comprising viewable content comprising general information relating to the service provided for the client by the service provider.

5. The method of claim 4, wherein selecting the brochure displaying general information comprises the general information being displayed on the brochure or included in the viewable content of the optical disc fulfills necessary requirements of an administrative body governing the practice of the service provider for the service provider to bill the client for providing the general information for the client.

6. The method of claim 5, further comprising billing the client for providing the general information for the client.

7. The method of claim 1, wherein selecting the brochure displaying general information comprises the general information being displayed on at least one business card or referral card disposed in the brochure.

8. The method of claim 1, wherein inserting the future-appointment information into the brochure along with a gift card comprises the future-service information being displayed on at least one business card or referral card disposed in the brochure.

9. An appointment notifier comprising:
a foldable reminder packet comprising at least one sheet of material folded into at least two panels, at least one of the panels displaying general information related to a service provided for a client by a service provider, at least one of the panels displaying a reminder of a future service appointment between the client and the service provider, the reminder comprising a date and a time of day of the future service appointment; and
a gift card provided for use by the client, the gift card for a predetermined amount of money and configured and arranged to be removably retained by the reminder packet.

10. The appointment notifier of claim 9, wherein the general information displayed on at least one of the panels fulfills necessary requirements of an administrative body governing the practice of the service provider for the service provider to bill the client for providing the general information for the client.

11. The appointment notifier of claim 9, wherein the gift card is redeemable toward at least one service or product offered by a third-party business.

12. The appointment notifier of claim 11, wherein at least one of the panels displays information related to a third-party entity other than the third-party business.

13. The appointment notifier of claim 11, wherein the cost of the reminder packet is at least partially paid for by at least one of the third-party business or the third-party entity.

14. The appointment notifier of claim 9, further comprising at least one business card or referral card.

15. A service package comprising:
a brochure displaying general information related to a service provided for a client by a service provider, the brochure comprising at least one sheet of material folded into at least two panels;
an appointment notifier configured and arranged for insertion into the brochure, the appointment notifier comprising
a foldable reminder packet comprising at least one sheet of material folded into at least two panels, at least one of the panels displaying general information related to a service provided for a client by a service provider, at least one of the panels displaying a reminder of a future service appointment between the client and the service provider, the reminder comprising a date and a time of day of the future service appointment, and
a gift card provided for use by the client, the gift card for a predetermined amount of money and configured and arranged to be removably retained by the reminder packet; and
a client-specific insert comprising at least one sheet of material displaying client-specific information relating to the service provided for the client by the service provider, the client-specific insert configured and arranged for insertion into the brochure.

16. The service package of claim 15, wherein the gift card is redeemable toward at least one service or product offered by a first third-party business.

17. The service package of claim 16, wherein the brochure displays information related to a third-party entity other than the first third-party business.

18. The service package of claim 16, wherein the cost of the service package is at least partially paid for by at least one of the first third-party business or the third-party entity.

19. The service package of claim 15, further comprising at least one post-service item related to the service provided for the client by service provider.

20. The service package of claim 19, wherein the at least one post-service item is a product of a second third-party business.

21. The service package of claim 20, wherein the brochure displays information related to the second third-party business.

22. The service package of claim 20, wherein the cost of the service package is at least partially paid for by the second third-party business.

23. The service package of claim 15, further comprising an optical disc, the optical disc comprising viewable content, the viewable content comprising general information related to the service provided for the client by the service provider.

24. The service package of claim 20, wherein the general information displayed on at least one of the panels of the brochure or included on the viewable content of the optical disc fulfills necessary requirements of an administrative body governing the practice of the service provider for the service provider to bill the client for providing the general information for the client.

25. The service package of claim 15, further comprising at least one business card or referral card.
